(19) United States
(12) Patent Application Publication
(10) Pub. No.: US 2016/0178756 A1
(43) Pub. Date: Jun. 23, 2016

(54) TRACT-LOCK BASED STUDENT (HUMAN) LOCATION DATA SYSTEM

(71) Applicant: WolfGIS, LLC, Pell City, AL (US)

(72) Inventors: TEMPLETON BRIGGS, III, Snohomish, WA (US); JOHN MICHAEL GOLDEN, Pell City, AL (US)

(73) Assignee: WolfGIS, LLC, Pell City, AL (US)

(21) Appl. No.: 14/979,247

(22) Filed: Dec. 22, 2015

Related U.S. Application Data
(60) Provisional application No. 62/095,305, filed on Dec. 22, 2014.

(51) Int. Cl. G01S 19/51; H04W 4/02; G06F 17/30

(52) U.S. Cl. CPC G01S 19/51; G06F 17/30241; G06F 17/30061; H04W 4/02; G01S 2205/008

(57) ABSTRACT

A Tract-Lock based student (human) location data system is described with inherent properties for providing precise human location data only when within a specified boundary.

### CROSS-REFERENCE TO RELATED APPLICATION

This application claims the benefit of U.S. Provisional Application No. 62/095,305 filed on Dec. 22, 2014, which is incorporated herein by reference in its entirety.

### FIELD OF THE INVENTION

The present invention is generally directed to a system of devices using geo-positioning software, on-board location services, and web communication services of smart mobile devices or custom, purpose built location devices to determine an earth-based location within a specified boundary. In greater particularity, the present invention relates to the calculation of geo-positioning boundaries with respect to a user's current location on a geo-positionally known tract of land.

### BACKGROUND OF THE INVENTION

The use of global position systems (GPS) to determine the terrestrial position of a portable device is well-known in the art. For instance, U.S. Pat. No. 5,375,059 to Kyrtsos et al., U.S. Pat. No. 5,438,517 to Sennott et al., and U.S. Pat. 5,490,073 to Kyrtsos each describe a navigational system for vehicles utilizing the electromagnetic signals received from GPS satellites. The aforementioned patents (U.S. Pat. No. 5,375,059; U.S. Pat. No. 5,438,517; U.S. Pat. No. 5,490,073) are hereby incorporated by reference.

The current systems utilize passive or active Radio Frequency Identification (RFID) tags issued to each student/person, the associated base station network, and a data server. Short range passive RFID systems offer short tag-to-reader ranges and generally are used to record passage through a reader-equipped portal, or from a short range base station, with location data thus limited to buildings, rooms and zones, at a reasonable installation cost. Longer range active RFID systems provide more precise location data, given the array of reader base stations required for campus/facility coverage, at significantly higher costs (battery powered, active RFID tag and an extensive base station radio network, including AC power provision in open areas).

Exiting art systems have not been readily accepted because the tag may be tracked anywhere, not just on campus. Indeed, most roll-out attempts have been abandoned because of this. Short range passive RFID systems offer short tag-to-reader ranges and generally are used to record passage through a reader-equipped portal, or from a short range base station, with location data thus limited to buildings, rooms and zones, at a reasonable installation cost.

The presently disclosed global positioning system eliminates the RF tag and most of the hardware requirements of the existing art. The elimination of the RF tag results in increased privacy as institutions can assure and prove to their users that they are only tracked when within the designated facility boundaries.

### SUMMARY OF THE INVENTION

This invention combines Wolf-Tek's pending Tract-Lock patent, with the on-board location services (GPS and WiFi) and web communication services (via cell and WiFi) of smart mobile devices (phones and pads), to provide precise campus/facility-wide student/human location data, only when on the campus/facility. The aforementioned pending patent application (U.S. patent application Ser. No. 13/525,290) is incorporated herein by reference.

This system provides at all times the precise location of every human and/or student present within the boundaries of a campus or facility, primarily for but not limited to security purposes, without raising privacy concerns by making the human trackable when not within the boundaries of the facility by taking full advantage of the convergence on these devices (phones and pads), to eliminate the RF tag and most of the hardware requirements of existing art, sharing only the data base server with them.

### BRIEF DESCRIPTION OF THE DRAWINGS

Further advantages of the invention will become apparent by reference to the detailed description of preferred embodiments when considered in conjunction with the drawings:

FIG. 1 is a general communication system diagram showing how a mobile device located within a facility boundary is connected to various communication elements of the system.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

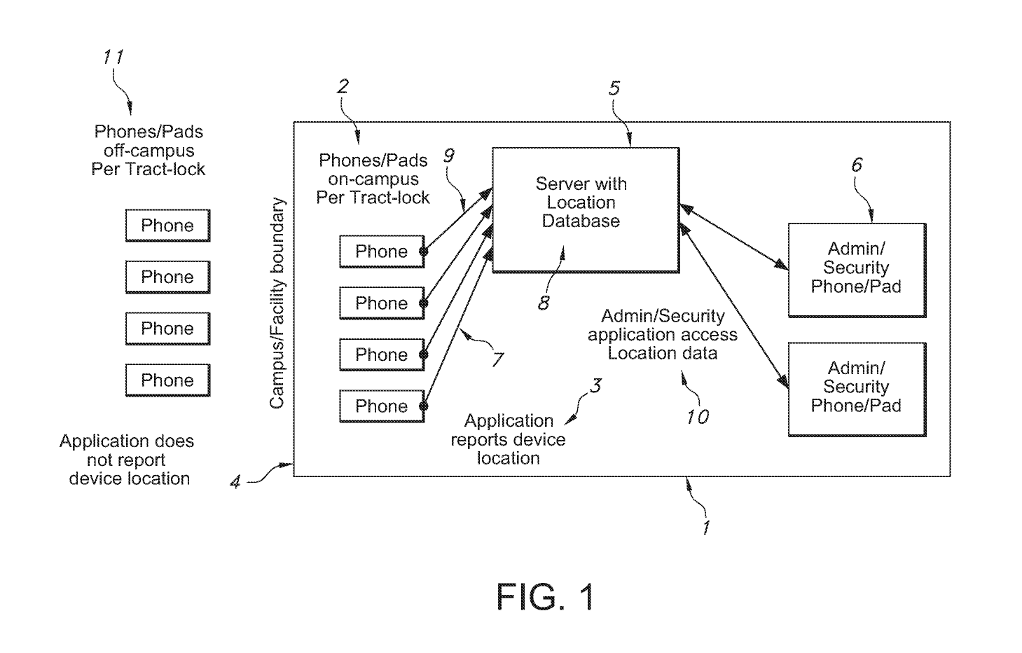

Referring to the drawings, FIG. 1. illustrates the communication of geo-positional data to and from mobile devices (phones/pads) 2 within the designated boundary 4. The system 1 consists primarily of a smart mobile device 2, a mobile device application 3, and a secure server 5.

The preferred embodiment of the smart mobile device 2 having an on-board global positioning system and a cellular data plan or a custom built location device incorporating those functions and able to run applications.

The Student/Individual Application 3 reports each person's location by precise latitude and longitude, as derived by on-board location services when the device is within the designated boundary 4. The location is not reported when the device 11 is not within the designated boundary 4 eliminating privacy concerns. The encoded location data 7 is transmitted via cell or WiFi 9 to a URL for a secure web/data base server 5. Personal identification data is not transmitted, only an encoded reference number.

The location data transmission interval may be set within a range spanning what is required for reasonable location accuracy for a person in motion and the system traffic limitation. The Application 3 could also vary this rate depending on whether the device is in motion or not, using the on-board device accelerometer to detect motion.

Potential embodiments of the Student/Individual Application 3 including a panic button and the ability to silently, via menu or chat, provide situational security information to administration.

Given existing cellular coverage throughout the campus/facility, and given existing WiFi infrastructure coverage, additional WiFi and/or cellular access points would be placed throughout the campus/facility, based on a comprehensive site survey.

The secure server 5 can receive and maintain a location database 8, via its web portal, of each human's recent and archived location data 7. The secure server 5 can perform data analysis and communicate to the mobile device of administration 6. The communication to administration can be programmed to communicate if a device stops transmitting data within the designated bounds 4 or for a specified zone within the designated bounds.

Potential embodiments of the location database 8 providing real time master on-campus/off-campus lists, location of a specific person, route tracing for a specific person for a specified time period, last known location of a person who's device ceased transmitting while still within the facility boundary by initiating a security response, notification of intrusion into No Trespass zones by initiating a security response, attendance records, and the ability to ramp up the rate of the Student/Individual Application 3 location data 7 reporting for a specific individual, group, or all individuals within a specified zone.

The Administration/Security Application 10 provides location data 7 to the PC or mobile device (phone/pad) of Administration/Security personnel 6. Presentation of the location data 7 by the Application on the PC or device 6 may take on any combination of the entire range of possible map-based, geographic and alpha-numeric forms including dots on a map, or within pre-defined zones; lists or quantities by location; or movement track for a past period of time, or live, for a particular group of persons.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We hereby claim:

1. A system for locating a user on a geo-positionally known tract of land, comprising:
a. an electronic device held by said user having means for communicating wirelessly through the internet to a remote internet protocol address, means for determining a latitude and longitude for said device on the Earth, a secure server, a battery, a speaker, a universal serial port external connector, means for communicating over a cellular network, and means for controlling the internal electronics of said device;
b. means running on said device for loading a geographic position boundary;
c. means running on said device for calculating whether said user is geographically positioned within said boundary and taking actions to communicate to said secure server said user's position relative to said boundary; and,
d. server means in communication with said device for remotely managing a database record holding information associated with the location, status, and geo-positioning boundary files associated with said user.

2. The system as recited in claim 1, further including means running on said device for calculating a geographic position boundary upon receipt of a land tract file holding geographic information representing the perimeter of a land tract represented by said land tract file, and wherein said boundary corresponds to said perimeter of said land tract.

3. The system as recited in claim 2, further including means resident on said secure server means for accepting an uploaded land tract file and associating said land tract wile with said database record.

4. The system as recited in claim 3, further indicating a display for displaying said user's position on said land tract.

5. A system for locating a user on a geo-positionally known tract of land, comprising:
a. an electronic device held by said user having means for communicating wirelessly through the internet to a remote internet protocol address, means for determining a latitude and longitude for said device on the Earth, a secure server, a battery, a speaker, a universal serial port external connector, means for communicating over a cellular network, and means for controlling the internal electronics of said device;
b. means running on said device for loading a geographic position boundary;
c. means running on said device for calculating whether said user is geographically positioned within said boundary and taking actions to communicate to said secure server said user's position relative to said boundary; and,
d. means running on said device for calculating a geographic position boundary upon the receipt of a land tract file holding geographic information representing the perimeter of a land tract represented by said land tract file, and wherein said boundary corresponds to said perimeter of said land tract.

6. The system as recited in claim 5, further including means resident on said server means for accepting an uploaded land tract file and associating said land tract file with said database record.

7. The system as recited in claim 6, further comprising means running on said server for managing a plurality of land tract files associated with said user and downloading said files into said electronic device upon request by said user or a second user.

8. The system as recited in claim 7, further including a display for displaying said person's position on said land tract.

9. In an electronic device held by a user having means for communicating wireless through the Internet to a remote interne protocol address, means for determining a latitude and longitude for said electronic device on the Earth, a batter, a speaker, a universal serial port external connector, means for communicating over a cellular network, and means for controlling the internal electronics of said device, a method for guiding the movements of said user within a tract of land comprising the steps of:
a. loading geographic information representing a land tract into said electronic device;
b. calculating a geographic boundary comprising a perimeter of said land tract; and
c. continuously monitoring said user's geographic position within said land tract and issuing a notification warning upon the transit of said boundary.

10. The method of claim 9, further including the step of downloading a land tract file into said electronic device.

11. The method as recited in claim 10, further including the step of communicating over a global communications network with a database computer or second electronic device managing a database record representing geographical information associated with said user.

12. The method as recited in claim 11, further including the step of uploading a plurality of land tract files to a secure server and associating those files with a geographic profile of said user.

13. The method as recited in claim 12, further including the step of continuously updating said database record with position, trajectory, and travel history of said user.

14. The method of claim 13, further including the step of displaying the position of said user on said land tract in association with a map overlay.

15. The method as recited in claim 14, further including the step of calculating a buffer zone prior to transiting said boundary and issuing a notification warning to said second electronic device upon the transit into said buffer zone.

16. The method as recited in claim 15, further including the step of issuing a notification warning to a second electronic device if said user's electronic device stops transmitting data within the designated geographic position boundary.

17. The method as recited in claim 9, further including the step of issuing a notification warning to said second electronic device if said user's electronic device stops transmitting data within the designated geographic position boundary.

18. The method as recited in claim 17, further including the step of uploading a plurality of land tract files to a database computer or second electronic device and associating those files with a geographic profile of said user.

19. The system as recited in claim 5, further providing notification of intrusion into said designated geographic position boundary.

20. The system as recited in claim 6, wherein said database record can take on any combination of the entire range of possible map-based, geographic and alpha-numeric forms including dots on a map, or within pre-defined zones; lists or quantities by location; or movement track for a past period of time, or live, for a particular group of users.
